(19) United States
(12) Patent Application Publication
(10) Pub. No.: US 2026/0361022 A1
(43) Pub. Date: Nov. 12, 2026

(54) Seal Retainer For a Connector

(71) Applicant: TE Connectivity Solutions GmbH, Schaffhausen (CH)

(72) Inventors: Vinod Kumar, Bangalore (IN); Rohan Narang, Winston Salem, NC (US); Kevin McKee, Fremont, CA (US); David Procter, Middletown, PA (US)

(73) Assignee: TE Connectivity Solutions GmbH, Schaffhausen (CH)

(21) Appl. No.: 19/200,828

(22) Filed: May 7, 2025

(51) Int. Cl. H01R 13/52

(52) U.S. Cl. CPC H01R 13/5219

(57) ABSTRACT

A connector includes a housing, a seal disposed on the housing, and a pair of retention elements formed separately from the housing and removably attached to the housing in an attached position. The retention elements retain the seal on the housing in the attached position.

### FIELD OF THE INVENTION

The present invention relates to a connector and, more particularly, to a seal retainer for a connector.

### BACKGROUND OF THE INVENTION

An interface between a connector and a mating connector is commonly required to be protected from environmental conditions, such as the ingress of dust, water, or other contaminants. To protect the interface from the environmental conditions, at least one of the connector and the mating connector has an elastically deformable seal that is compressed between the connector and the mating connector in a mated state.

During the lifecycle of the connector, for example during mating and unmating or during handling of the connector, the seal can become dislodged from its seated position in the connector, which can impair the environmental protection provided by the seal. Retention of the seal can therefore be critical to the function and durability of the connector. Current seal retainers, however, are additional components of the connector and are generally unique to each size and form of connector, which increases manufacturing cost and requires inefficient inventory management.

### SUMMARY OF THE INVENTION

A connector includes a housing, a seal disposed on the housing, and a pair of retention elements formed separately from the housing and removably attached to the housing in an attached position. The retention elements retain the seal on the housing in the attached position.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is a perspective view of a retention element of the connector of FIG. 1;

FIG. 3 is a sectional perspective view of the connector of FIG. 1, taken along line 3-3;

FIG. 4A is a perspective view of a connector according to another embodiment having the retention element of FIG. 1;

FIG. 4B is a perspective view of a connector according to a further embodiment having the retention element of FIG. 1;

FIG. 5 is a perspective view of a connector according to another embodiment;

FIG. 6 is a perspective view of the connector of FIG. 5 with a retention element removed;

FIG. 7 is a perspective view of the retention element of the connector of FIG. 5;

FIG. 8A is a perspective view of a connector according to another embodiment having the retention element of FIG. 5;

FIG. 8B is a perspective view of a connector according to a further embodiment having the retention element of FIG. 5;

FIG. 9A is a perspective view of a connector according to another embodiment in an installation state;

FIG. 9B is a perspective view of the connector of FIG. 9A in a retention state;

FIG. 10A is a perspective view of a connector according to another embodiment in an installation state;

FIG. 10B is a perspective view of the connector of FIG. 10A in a retention state;

FIG. 11A is a perspective view of a connector according to another embodiment in an installation state; and

FIG. 11B is a perspective view of the connector of FIG. 11A in a retention state.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “longitudinal direction,” “lateral direction,” and “height direction.” These descriptors are merely for clarity of the description and for differentiation of the various directions. These directional descriptors do not imply or require any particular orientation of the disclosed elements.

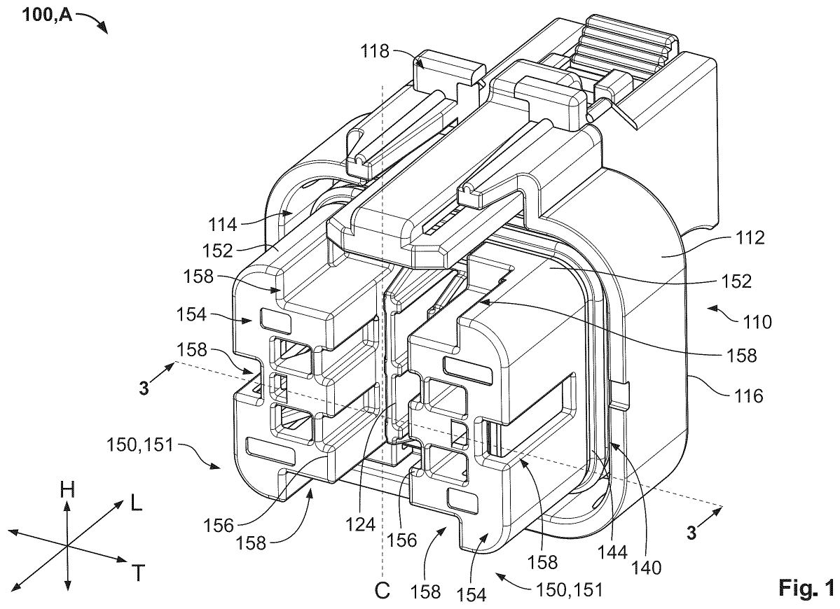

A connector is described herein with respect to different embodiments in FIGS. 1-11B. The connector 100, 100′, 100″, 100′″ according to the various embodiments will be described herein as a cap that is used, for example, to cover an open end of a wire harness. The connector 100, 100′, 100″, 100′″ does not contain terminals in the described embodiments, but the concepts described herein are not limited to connectors without terminals; the same embodiments of the retainer 150 described in detail below could also apply to a connector having terminals that mate with terminals of a mating connector in a mated position.

A connector 100 according to an embodiment is shown in FIGS. 1-3. The connector 100 includes a housing 110, a seal 140 disposed in the housing 110, and a retainer 150 retaining the seal 140 in the housing 110. In the embodiment of FIGS. 1-3, the retainer 150 is a pair of retention elements 151.

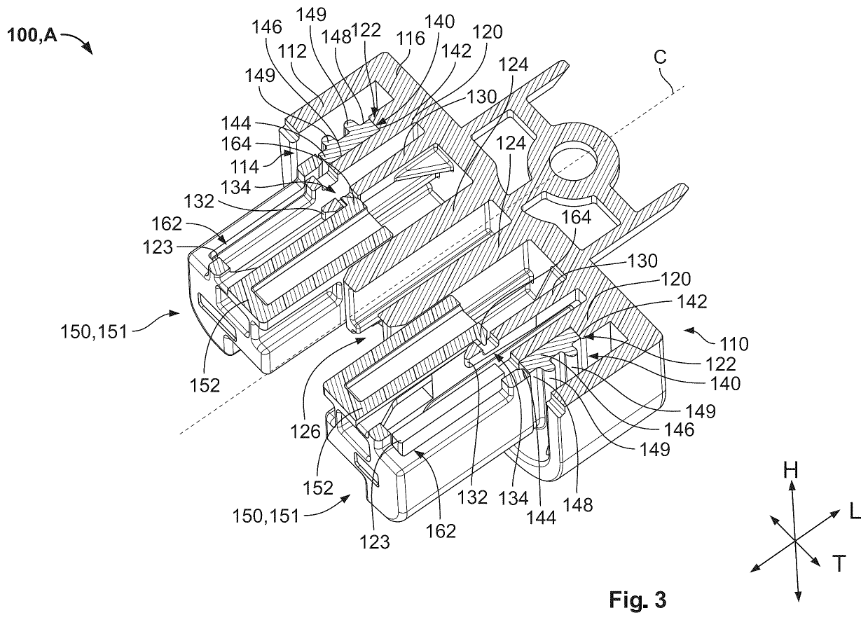

The housing 110, as shown in FIGS. 1 and 3, includes a shroud 112 and a rear wall 116 connected to the shroud 112. The shroud 112 and the rear wall 116 define a mating receiving space 114 that receives a mating connector matable with the connector 100. The housing 110, in the shown embodiment, has a connection member 118 on a side of the shroud 112 that is latched the connector 100 to the mating connector when the mating connector is positioned in the mating receiving space 114. The connection member 118 is a cantilevered latch in the shown embodiment and, in other embodiments, could be any type of releasable attachment element used to connect the connector 100 and the mating connector in the mated position.

As shown in FIG. 3, the housing 110 has a pair of first supports 120, a pair of second supports 124, and a pair of latch arms 130 extending from the rear wall 116. The first supports 120, the second supports 124, and the latch arms 130 extend into the mating receiving space 114 along a longitudinal direction L. The first supports 120, the second supports 124, and the latch arms 130 are mirrored with respect to a center line C of the housing 110 along a lateral direction T perpendicular to the longitudinal direction L; the second supports 124 are positioned adjacent to one another and separated by a gap 126 in the lateral direction T on opposite sides of the center line C, the latch arms 130 are positioned on opposite sides of the center line C with the second supports 124 between the latch arms 130, and the first supports 120 are positioned on opposite sides of the center line C with the second supports 124 and the latch arms 130 between the first supports 120 in the lateral direction T.

The first supports 120, as shown in FIG. 3, extend further than the second supports 124 and the latch arms 130 along the longitudinal direction L. The first supports 120 each have a notch 122 adjacent to the rear wall 116 along the longitudinal direction L and a support end 123 opposite the rear wall 116 along the longitudinal direction L.

The latch arms 130, as shown in FIG. 3, extend from the rear wall 116 to an angled end 132 opposite the rear wall 116 along the longitudinal direction L. The latch arms 130 each have a latch passageway 134 adjacent to the angled and 132.

In an embodiment, the latch arms 130 are elastically deflectable along the lateral direction T. The first supports 120 and the second supports 124 are more rigid than the latch arms 130.

The housing 110 is formed of an insulative material, such as a plastic. In an embodiment, the housing 110 is monolithically formed in a single piece from the insulative material. In other embodiments, the housing 110 may be formed from a plurality of pieces of the insulative material assembled together to form the elements of the housing 110 described above.

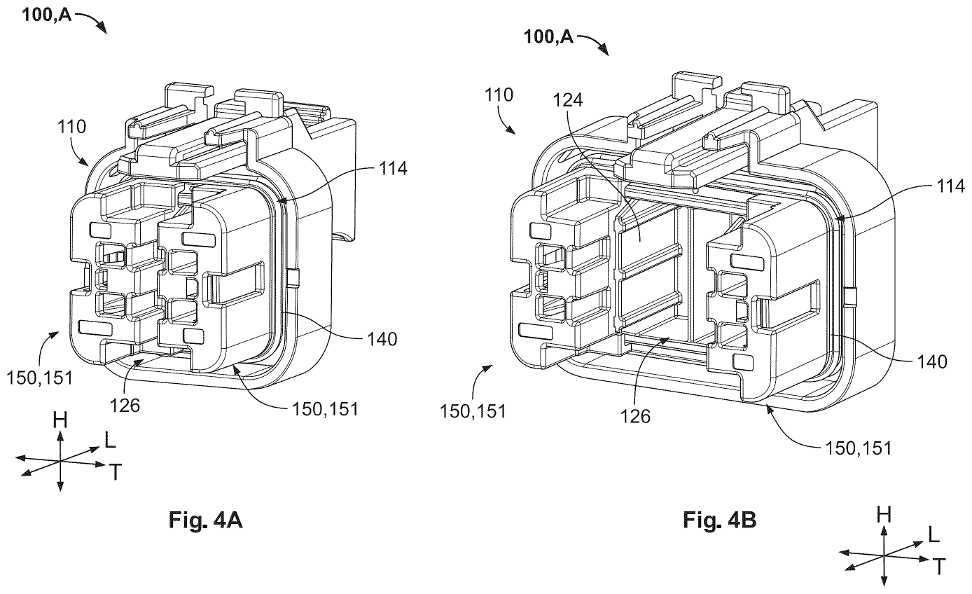

The seal 140, as shown in FIGS. 1 and 3, is a continuous ring that is formed of an elastically deformable material, such as silicone. In the embodiment of FIGS. 1 and 3, the seal 140 has an approximately rounded square shape. In other embodiments, the seal 140 may have other shapes, such as a rounded rectangular shape as described below with respect to FIG. 4B, or a circular shape. The seal 140 has a first end 142 and a second end 144 opposite the first end 142 along the longitudinal direction L, and an inner side 146 and an outer side 148 opposite the inner side 148 along the lateral direction T. The seal 140 has a plurality of ribs 149 that protrude from the outer side 148.

The retention elements 151 of the retainer 150 are identical to one another, as shown in FIGS. 1 and 3. One of the retention elements 151 will be described in detail herein, but the description applies equally to each of the retention elements 151 of the retainer 150.

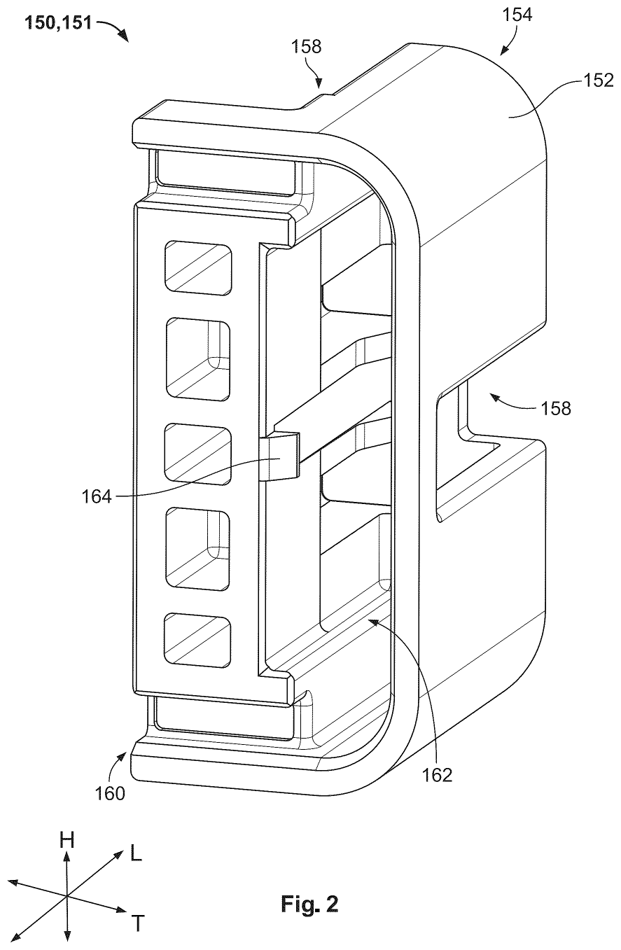

The retention element 151, as shown in FIGS. 1 and 2, has a body 152 with a front side 154 and a back side 160 opposite the front side 154 along the longitudinal direction L. As shown in FIG. 1, the front side 154 has an inner shape 156 on a side of the body 152 and a plurality of recesses 158 extending into different portions of the body 152 along the longitudinal direction L. As shown in FIG. 2, on the back side 160 of each of the retention elements 151, the body 152 defines a support passageway 162 extending along the longitudinal direction L. The retention element 151 has a protrusion 164 extending from the body 152 into the support passageway 162 in the lateral direction T.

The retention elements 151 are each formed of an insulative material, such as a plastic, and are formed separately from the housing 110. In the shown embodiment, the retention elements 151 are each monolithically formed in a single piece from the insulative material. In other embodiments, the retention elements 151 can each be formed of a plurality of pieces of the insulative material assembled together to form the components of the retention elements 151 described herein.

An assembly of the connector 100 will now be described primarily with respect to FIGS. 1 and 3.

The seal 140 is inserted into the housing 110 along the longitudinal direction L and, as shown in FIG. 3, is positioned in the mating receiving space 114. The seal 140 is disposed on and extends around the first supports 120. The seal 140 is inserted until it is positioned in the notch 122 in each of the first supports 120. When fully seated in the housing 110 in an attached position A of the connector 100 shown in FIG. 3, the inner side 146 of the seal 140 abuts the first supports 120, the first end 142 abuts the housing 110, and the ribs 149 protrude outward into the mating receiving space 114.

With the seal 140 positioned on the housing 110 as shown in FIGS. 1 and 3, the retention elements 151 of the retainer 150 are then inserted into the mating receiving space 114 along the longitudinal direction L into the attached position A. The back side 160 of the retention elements 151 is inserted into the mating receiving space 114 and the front side 154 faces away from the housing 110 in the attached position A. As the retention elements 151 are inserted, the body 152 of each of the elements 151 is positioned on a side of one of the second supports 124 in the lateral direction T. Each of the first supports 120 and each of the latch arms 130 is received in the support passageway 162 of one of the retention elements 151.

As the retention elements 151 move toward the attached position A, the protrusion 164 abuts the angled end 132 of one of the latch arms 130 and deflects the latch arm 130 in the lateral direction T. When the retention element 151 reaches the attached position A, the latch arm 130 elastically returns and the protrusion 164 engages the latch passageway 134 of the latch arm 130, removably securing the retention element 151 to the housing 110 as shown in FIG. 3. In another embodiment, the latch arm 130 may be more rigid than the body 152 of the retention element 151, and the body 152 having the protrusion 164 may deflect before engaging the latch passageway 134 in the attached position A. In the attached position A, the support end 123 of each of the first supports 120 abuts against the body 152 of the retention element 151.

In the attached position A, the removable attachment of the retention elements 151 to the housing 110 by the latching of the protrusions 164 to the latch arms 130 positions the body 152 of the retention elements 151 in abutment with the seal 140. As shown in FIG. 3, the first end 142 of the seal 140 abuts the housing 110 and the second end 144 of the seal 140 abuts the retention element 151, retaining the seal 140 in position along the longitudinal direction L.

The retention of the seal 140 provided by the retention elements 151 of the retainer 150 prevents the seal 140 from dislodging or otherwise moving out of position during mating and unmating of the connector 100 with a mating connector, improving the reliability of an environmental seal over time. As shown in FIG. 1, the recesses 158 of the retention elements 151 are positioned to accommodate a plurality of different locations of keys on a plurality of different mating connectors that are each matable with the connector 100; the same retention elements 151 can thus be used with a number of different mating connectors, improving the flexibility of the retainer 150 and decreasing manufacturing and inventory costs. As shown in FIG. 1, the retention elements 151 are identical to one another and are positioned mirrored with respect to one another about the center line C of the housing 110 to retain the seal 140 in the attached position A. Forming the retention elements 151 identically to one another further decreases manufacturing and inventory costs.

The same retention elements 151 of the embodiment shown in FIGS. 1-3 are also usable with other connectors 100, as shown in FIGS. 4A and 4B.

The connectors 100 shown in FIGS. 4A and 4B are identical to the connector 100 shown in FIGS. 1-3, except a size of the gap 126 between the second supports 124 in the lateral direction T is different in each of the connectors 100 to accommodate mating connectors of different size. The housings 110 of the various connectors 100 each have a different width in the lateral direction T and the seal 140 used in the respective housings 110 has a size corresponding to the housing 110; as shown in FIGS. 4A and 4B, the seal 140 can have a rounded square or rounded rectangular shape to fit within the mating receiving space 114 on the housing 110. Other than the overall size, the components of the housing 110 and the seal 140, and the fit of the seal 140 in the housing 110, in each of FIGS. 4A and 4B is the same as described above.

In all the various connectors 100 shown in FIGS. 1-4B, the retainer 150 retaining the seal 140 is formed by the same two retention elements 151 that removably attach to the housing 110 in the same manner. The retention elements 151 are thus interchangeably removably attachable to housings 110 of different sizes to retain seals 140 of different sizes, further improving flexibility and decreasing manufacturing costs.

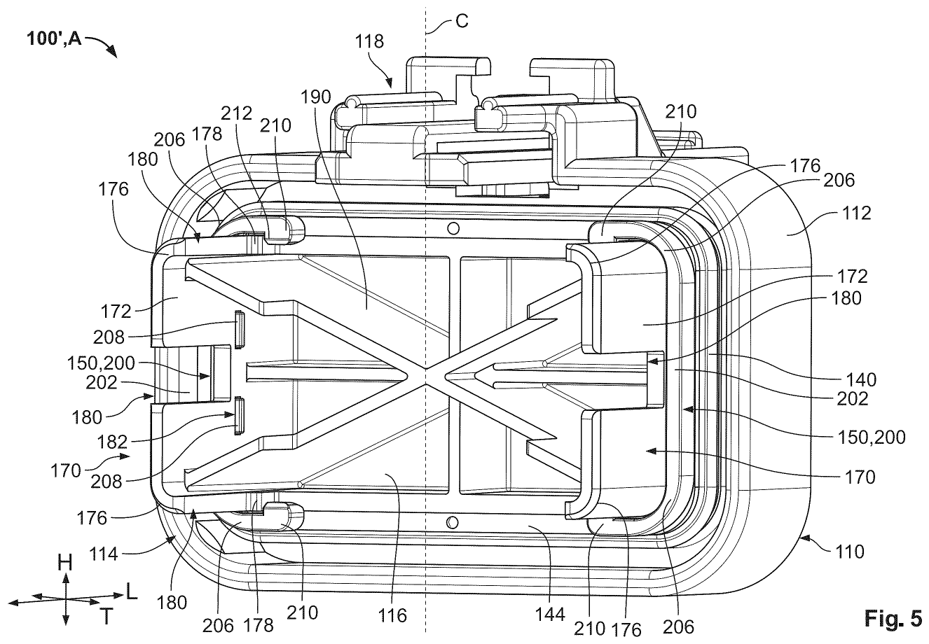

A connector 100′ according to another embodiment is shown in FIGS. 5-7. The connector 100′ includes a housing 110, a seal 140 disposed in the housing 110, and a retainer 150 retaining the seal 140 in the housing 110. In the embodiment of FIGS. 5-7, the retainer 150 is a pair of retention elements 200. Like reference numbers refer to like elements with respect to the embodiment of the connector 100 shown in FIGS. 1-4B and described above; primarily the differences of the connector 100′ will be described in detail herein.

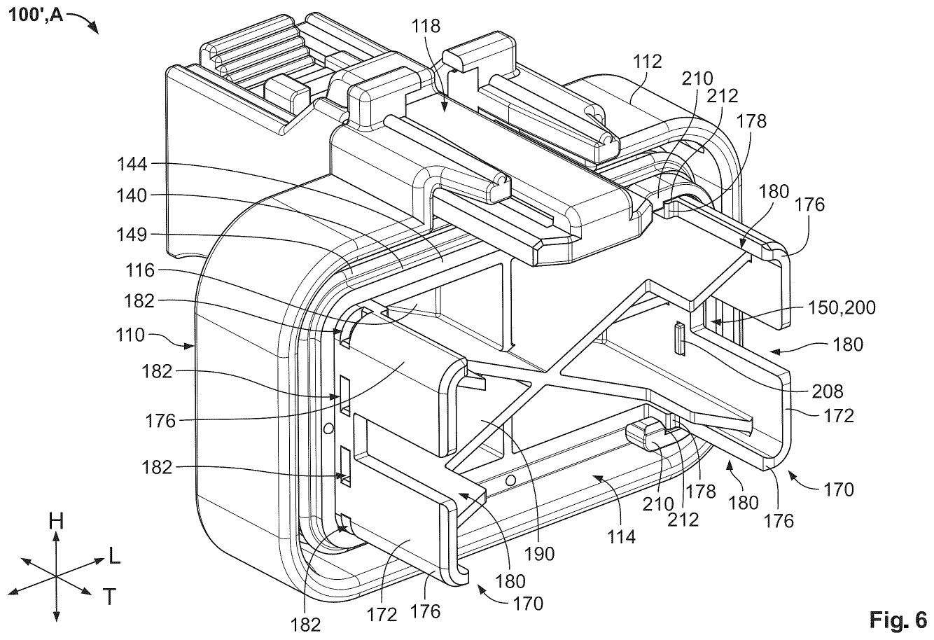

The housing 110 of the connector 100′, as shown in FIGS. 5 and 6, has a shroud 112 and a rear wall 116 defining a mating receiving space 114, as described with respect to the housing 110 of the connector 100 above. The housing 110 shown in FIGS. 5 and 6, has a pair of supports 170 that extend from the rear wall 116 into the mating receiving space 114 along the longitudinal direction L instead of the first supports 120, the second supports 124, and the latch arms 130 of the embodiment described above with respect to FIGS. 1-3 above.

Each of the supports 170, as shown in FIGS. 5 and 6, has a wall portion 172 and a pair of curved ends 176 at opposite ends of the wall portion 172 in a height direction H perpendicular to the longitudinal direction L and the lateral direction T. The supports 170 have a plurality of support notches 180 extending into the wall portion 172 and the curved ends 176 along the longitudinal direction L. The support notches 180 create a thickened portion 178 of the curved ends 176 adjacent to the rear wall 116. The supports 170 have a plurality of support passageways 182 extending through the wall portion 172 and the curved ends 176 in the lateral direction T and the height direction H, shown particularly in FIG. 6. The supports 170 are identical and are mirrored with respect to one another about the center line C of the housing 110; the supports 170 have the same elements, even though some elements may be obscured or unlabeled in either FIG. 5 or FIG. 6. The housing 110 has a support structure 190 on the rear wall 116 extending between and supporting the supports 170.

In the embodiment of FIGS. 5-7, the retention elements 200 of the retainer 150 are identical to one another, as shown in FIGS. 5 and 6. One of the retention elements 200 will be described in detail herein, but the description applies equally to each of the retention elements 200 of the retainer 150.

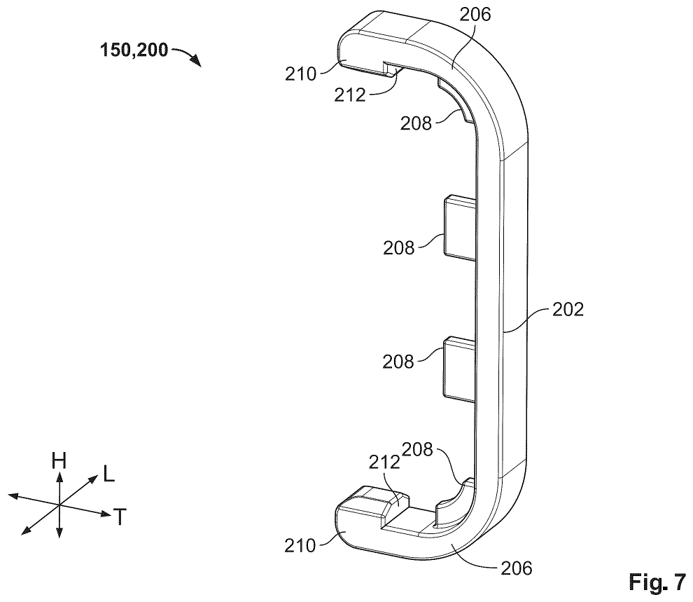

The retention element 200, as shown in detail in FIG. 7, is a C-shaped element having a central portion 202 and a pair of curved portions 206 at opposite ends of the central portion 202 in the height direction H. The curved portion 206 each have a latching nub 210 at an end of the curved portion 206 opposite the central portion 202. The latching nubs 210 protrude from the curved portion 206 in the height direction H and have a latch surface 212 facing the central portion 202. The retention element 200 has a plurality of retention protrusions 208 extending from the central portion 202 and the curved portions 206 in the lateral direction T and the height direction H.

The retention elements 200 are each formed of an insulative material, such as a plastic, and are formed separately from the housing 110. The material of the retention elements 200 permits the latching nubs 210 to elastically deflect with respect to the central portion 202. In the shown embodiment, the retention elements 200 are each monolithically formed in a single piece from the insulative material. In other embodiments, the retention elements 200 can each be formed of a plurality of pieces of the insulative material assembled together to form the components of the retention elements 200 described herein.

An assembly of the connector 100′ will now be described primarily with respect to FIGS. 5 and 6.

The seal 140 is inserted into the housing 110 along the longitudinal direction L and, as shown in FIGS. 5 and 6, is positioned in the mating receiving space 114. The seal 140 is disposed on and extends around the supports 170. The seal 140 is inserted around the supports 170 until the first end 142 of the seal 140 abuts the rear wall 116 of the housing 110. In this position, the ribs 149 protrude outward into the mating receiving space 114.

With the seal 140 positioned on the housing 110 as shown in FIG. 6, the retention elements 200 of the retainer 150 are then inserted into the mating receiving space 114 along the lateral direction L into the attached position A. The retention elements 200 are each snap-fit onto one of the supports 170 in the lateral direction T; the latching nubs 210 of each retention element 200 are snap-fit around the curved ends 176 of the support 170. As the retention element 200 is moved toward the support 170 in the lateral direction T, the latching nubs 210 contact the curved ends 176 and deflect outward. When the retention element 200 reaches the position shown in FIG. 5, the latching nubs 210 elastically return and engage around the curved ends 176 of the support 170, with the latch surface 212 of each of the latching nubs 210 engaging the thickened portion 178 of the curved end 176. The curved portions 206 of the retention element 200 abut the curved ends 176 of the support 170. The retention protrusions 208 of the retention element 200 are each received in one of the support passageways 182 of the support 170 as the retention element 200 is moved into the attached position A in the lateral direction T.

In the attached position A, the removable attachment of the retention elements 200 to the housing 110 by the latching of the latching nubs 210 to the supports 170 positions the retention elements 200 in abutment with the seal 140. The first end 142 of the seal 140 abuts the housing 110 and the second end 144 of the seal 140 abuts the retention elements 200, retaining the seal 140 in position along the longitudinal direction L.

Similarly to the retention elements 151, the retention of the seal 140 by the retention elements 200 of the retainer 150 prevents the seal 140 from dislodging to improve reliability of the environmental seal. As shown in FIG. 5, the support notches 180 of the supports 170 are positioned to accommodate a plurality of different locations of keys on a plurality of different mating connectors that are each matable with the connector 100′; the same retention elements 200 can thus be used with a number of different mating connectors, improving the flexibility of the retainer 150 and decreasing manufacturing and inventory costs. As shown in FIG. 5, the retention elements 200 are identical to one another and are positioned mirrored with respect to one another about the center line C of the housing 110 to retain the seal 140 in the attached position A. Forming the retention elements 200 identically to one another further decreases manufacturing and inventory costs.

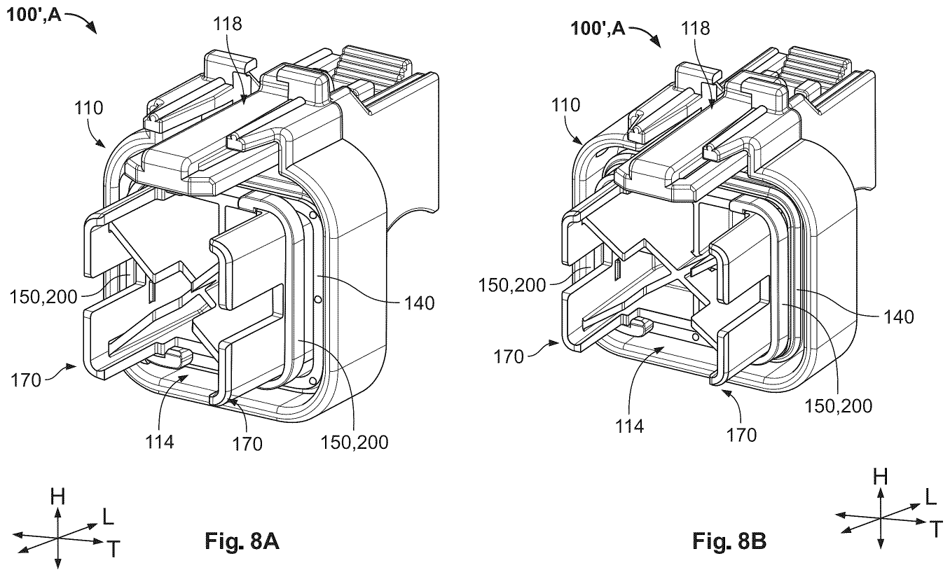

The same retention elements 200 of the embodiment shown in FIGS. 5-7 are also usable with other connectors 100′, as shown in FIGS. 8A and 8B.

The connectors 100′ shown in FIGS. 8A and 8B are identical to the connector 100′ shown in FIGS. 5-7, except width of the housing 110 between the supports 170 is different in each of the connectors 100′ to accommodate mating connectors of different size. The housings 110 of the various connectors 100′ each have a different width in the lateral direction T and the seal 140 used in the respective housings 110 has a size corresponding to the housing 110; as shown in FIGS. 8A and 8B, the seal 140 can have a rounded square or rounded rectangular shape to fit within the mating receiving space 114 on the housing 110. Other than the overall size, the components of the housing 110 and the seal 140, and the fit of the seal 140 in the housing 110, in each of FIGS. 8A and 8B is the same as described in FIGS. 5 and 6.

In all the various connectors 100′ shown in FIGS. 5-8B, the retainer 150 retaining the seal 140 is formed by the same two retention elements 200 that removably attach to the housing 110 in the same manner. The retention elements 200 are thus interchangeably removably attachable to housings 110 of different sizes to retain seals 140 of different sizes, further improving flexibility and decreasing manufacturing costs.

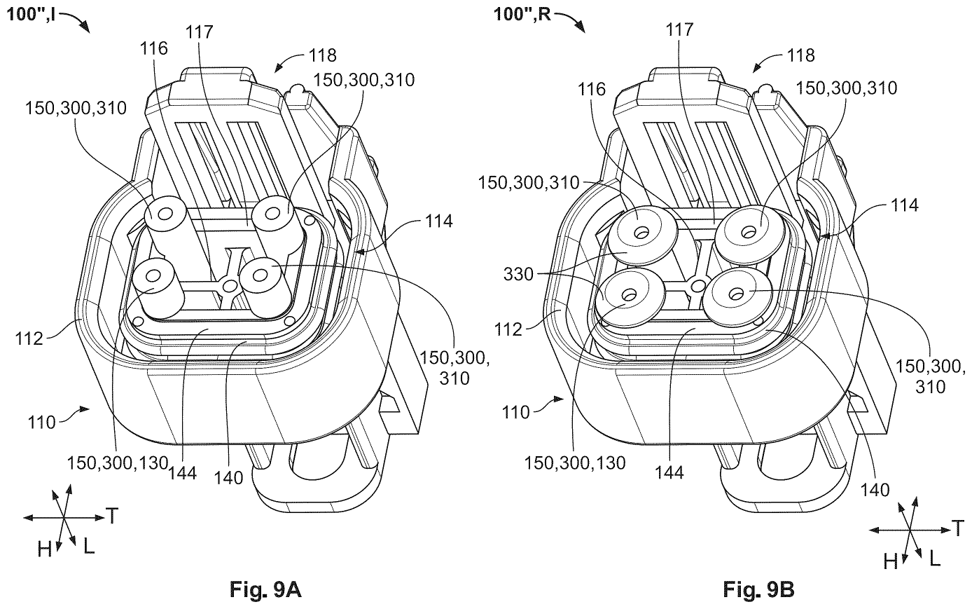

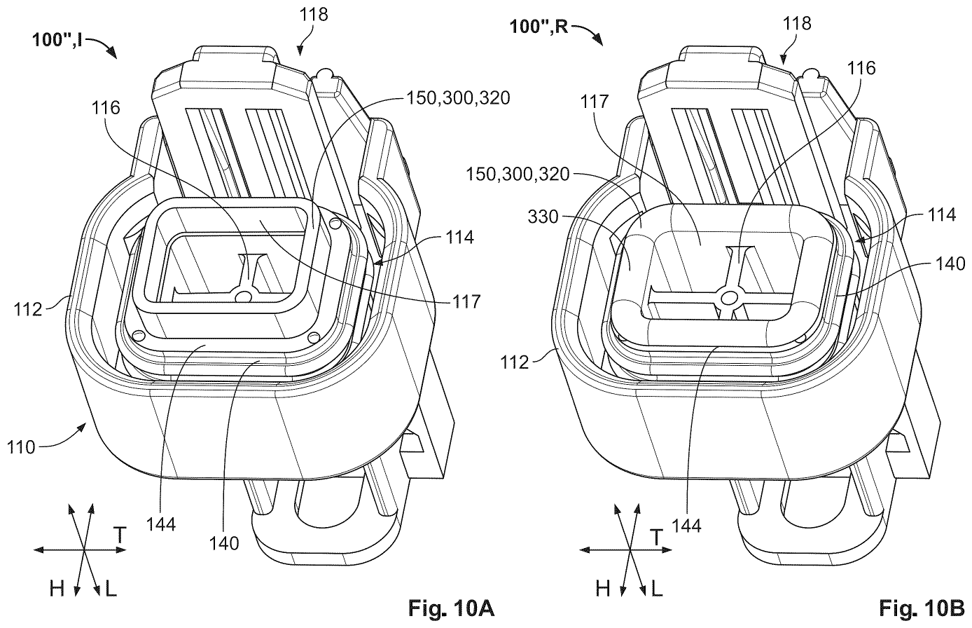

A connector 100″ according to further embodiments is shown in FIGS. 9A-10B. The connector 100″ includes a housing 110, a seal 140, and a retainer 150 retaining the seal 140 in the housing 110. In the embodiments of FIGS. 9A-10B, the retainer 150 is at least one protruding housing element 300. Like reference numbers refer to like elements with respect to the embodiments of the connector 100, 100′ shown in FIGS. 1-8B and described above; primarily the differences of the connector 100″ will be described in detail herein.

The housing 110 of the connector 100″, as shown in FIGS. 9A and 9B, has a shroud 112 and a rear wall 116 defining a mating receiving space 114. The housing 110 shown in FIGS. 9A and 9B has a seal support 117 positioned in the mating receiving space 114 and separated from the shroud 112.

In the embodiment shown in FIGS. 9A and 9B, the retainer 150 is a plurality of protruding housing elements 300 that extend from the seal support 117 along the longitudinal direction L. The protruding housing elements 300 that form the retainer 150 are monolithically formed in a single piece with the housing 110 at the seal support 117. In the embodiment of FIGS. 9A and 9B, the protruding housing elements 300 are a plurality of cylinders 310 that extend from the seal support 117. In other embodiment, the protruding housing elements 300 could be any other shape that is capable of being transferred from an installation state I to a retention state R as described herein.

To assemble and retain the seal 140 on the connector 100″, the seal 140 is positioned around the protruding housing elements 300, with the protruding housing elements 300 in the installation state I shown in FIG. 9A, and inserted into the mating receiving space 114 along the longitudinal direction L. The seal 140 is moved along the longitudinal direction L until it is seated around the seal support 117 and the first end 142 of the seal 140 abuts the housing 110.

The protruding housing elements 300 are then heat swaged, or heated to a deformation temperature and pressed toward the housing 110 along the longitudinal direction L, to transfer the protruding housing elements 300 of the retainer from the installation state I to a retention state R shown in FIG. 9B. After the protruding housing elements 300 have been heated, pressed toward the housing 110, and cooled, a material of the protruding housing elements 300 retains the seal 140 in the retention state R. The protruding housing elements 300 are transferred from a first length in the installation state I of FIG. 9A to a second length shorter than the first length in the retention state R of FIG. 9B; the excess material moved toward the housing 110 in this process flows outward to form a flange 330. The flange 330 abuts the second end 144 of the seal 140 to retain the seal 140 in the housing 110 in the retention state R.

In another embodiment of the connector 100″ shown in FIGS. 10A and 10B, the housing 110 has one protruding housing element 300 instead of a plurality of protruding housing elements 300. The connector 100″ in FIGS. 10A and 10B is otherwise identical to the connector 100″ of FIGS. 9A and 9B. The single protruding housing element 300, formed as an approximately rectangular element 320 in the embodiment of FIGS. 10A and 10B, is likewise heat swaged to transfer the protruding housing element 300 from the installation state I to the retention state R and form a flange 330 from a material of the protruding housing element 300 that retains the seal 140 in the housing 110.

The retention of the seal 140 provided by heat swaging the protruding housing element 300 prevents the seal 140 from dislodging, which improves the reliability of the environmental seal formed by the connector 100″. Further, the seal 140 is retained in these embodiments by a retainer 150 that is monolithically formed with the housing 110, decreasing the number of parts necessary to retain the seal 140 and correspondingly decreasing manufacturing and inventory costs.

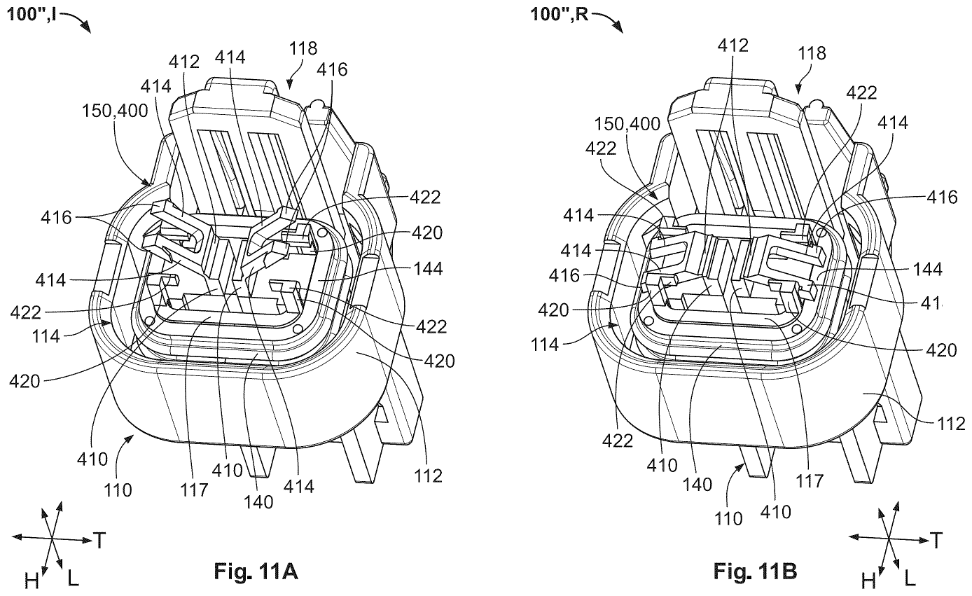

A connector 100′ according to another embodiment is shown in FIGS. 11A and 11B. The connector 100′″ includes a housing 110, a seal 140, and a retainer 150 retaining the seal 140 in the housing 140. In the embodiment of FIGS. 11A and 11B, the retainer 150 is a hinge retainer 400. Like reference numbers refer to like elements with respect to the embodiments of the connector 100″ shown in FIGS. 9A-10B and described above; primarily the differences of the connector 100′″ will be described in detail herein.

The housing 110 of the connector 100′″, as shown in FIGS. 11A and 11B, has a shroud 112 defining a mating receiving space 114. The housing 110 shown in FIGS. 11A and 11B has a seal support 117 positioned in the mating receiving space 114 and separated from the shroud 112.

The hinge retainer 400, as shown in FIGS. 11A and 11B, has a base 410 extending from the seal support 117 along the longitudinal direction L. A plurality of arms 414 of the hinge retainer 400 are connected to the base 410 and the housing 110 by a living hinge 412 and are rotatable about the living hinge 412 between the installation state I shown in FIG. 11A and the retention state R shown in FIG. 11B. Each of the arms 414 has a hinge protrusion 416 at an end opposite the living hinge 412.

The hinge retainer 400 includes a plurality of latch posts 420 protruding from the seal support 117, as shown in FIGS. 11A and 11B. The latch posts 420 each have a latch protrusion 422 on an end opposite the seal support 117.

The hinge retainer 400, including the base 410, the living hinge 412, the arms 414, and the latch posts 420, is monolithically formed in a single piece with the housing 110. The term “living hinge” is intended to mean that the hinge 412 is a piece of material monolithically formed with the other described elements of the hinge retainer 400 and the housing 110, but is sufficiently thin that it is flexible, allowing the elements described herein to rotate about the hinge 412 without plastically deforming or breaking the hinge 412.

To assemble and retain the seal 140 on the connector 100′″, the seal 140 is positioned around the hinge retainer 400, with the hinge retainer 400 in the installation state I shown in FIG. 11A, and inserted into the mating receiving space 114 along the longitudinal direction L. The seal 140 is moved along the longitudinal direction L until it is seated around the seal support 117 and the first end 142 of the seal 140 abuts the housing 110.

The hinge retainer 400 is then rotated about the living hinge 412 from the installation state I shown in FIG. 11A to the retention state R shown in FIG. 11B. As the hinge retainer 400 is rotated about the living hinge 412, the hinge protrusions 416 on the arms 414 move into contact with the latch protrusions 422 of the latch posts 420. At least one of the arms 414 and the latch posts 420 deflects until the retention state R shown in FIG. 11B is reached, in which the arms 414 and/or the latch posts 410 elastically return to a position in which the hinge protrusions 416 engage with the latch protrusions 422. In this retention state R, the arms 414 of the hinge retainer 400 abut the second end 144 of the seal 140 and retain the seal 140 in the housing 110.

The hinge retainer 400 shown in FIGS. 11A and 11B, having four arms 414 positioned opposite one another with each pair of arms 414 rotatable about one living hinge 412, is merely one possible embodiment of the hinge retainer 400. In other embodiments, the hinge retainer 400 could have any number of arms 414, or any structure, provided the elements of the hinge retainer 400 rotate about a living hinge 412 between an installation state I and a retention state R in which a part of the hinge retainer 400 abuts and retains the seal 140.

The retention of the seal 140 provided by the hinge retainer 400 prevents the seal 140 from dislodging, which improves the reliability of the environmental seal formed by the connector 100′″. Further, the seal 140 is retained in these embodiments by a retainer 150 that is monolithically formed with the housing 110, decreasing the number of parts necessary to retain the seal 140 and correspondingly decreasing manufacturing and inventory costs.

1. A connector, comprising:
a housing;
a seal disposed on the housing; and
a pair of retention elements formed separately from the housing and removably attached to the housing in an attached position, the retention elements retain the seal on the housing in the attached position.

2. The connector of claim 1, wherein the retention elements are identical to one another and are mirrored with respect to one another in the attached position.

3. The connector of claim 1, wherein the seal has a first end and a second end opposite the first end in a longitudinal direction, the first end abuts against the housing and the second end abuts against the retention elements in the attached position.

4. The connector of claim 1, wherein the housing is one of a plurality of housings each having a different width and the seal is one of a plurality of seals each corresponding in size to one of the plurality of housings, the same pair of retention elements are usable interchangeably to removably attach to each of the plurality of housings and retain the corresponding one of the plurality of seals.

5. The connector of claim 1, wherein the housing has a shroud defining a mating receiving space, the seal is disposed on the housing in the mating receiving space.

6. The connector of claim 5, wherein the housing has a pair of latch arms positioned in the mating receiving space and extending from a rear wall of the housing along a longitudinal direction, the pair of retention elements each have a protrusion engaging with one of the latch arms in the attached position.

7. The connector of claim 6, wherein the pair of retention elements are inserted into the mating receiving space along the longitudinal direction into the attached position.

8. The connector of claim 7, wherein the housing has a pair of first supports extending from the rear wall, each of the first supports has a notch in which the seal is seated and a support end opposite the rear wall abutting one of the retention elements in the attached position.

9. The connector of claim 6, wherein each of the retention elements has a body with a plurality of recesses on a front side facing away from the housing in the attached position, the recesses extend into different parts of the body to accommodate a plurality of different mating connectors that are each matable with the connector.

10. The connector of claim 5, wherein the retention elements each have a C-shape with a central portion and a pair of curved portions on opposite ends of the central portion.

11. The connector of claim 10, wherein the curved portions each have a latching nub that protrudes from the curved portion, the latching nubs of each curved portion are snap-fit around one of a pair of supports of the housing in the attached position.

12. The connector of claim 11, wherein the pair of retention elements are inserted into the mating receiving space along a lateral direction into the attached position.

13. The connector of claim 11, wherein the pair of supports each have a wall portion and a pair of curved ends at opposite ends of the wall portion, the curved portions of the retention elements abut the curved ends.

14. The connector of claim 13, wherein the pair of supports each have a plurality of support passageways extending through the wall portion and the curved ends, the pair of retention elements each have a plurality of retention protrusions extending into the support passageways in the attached position.

15. The connector of claim 13, wherein the pair of supports each have a plurality of support notches to accommodate a plurality of different mating connectors that are each matable with the connector.

16. A connector, comprising:
a housing having a retainer formed monolithically in a single piece with the housing; and
a seal disposed on the housing, the retainer is transferrable from an installation state in which the seal is inserted into the housing into a retention state in which the seal is retained in the housing.

17. The connector of claim 16, wherein the retainer is a protruding housing element that protrudes from a support seal of the housing around which the seal is disposed, the protruding housing element has a first length in the installation state and a second length that is shorter than the first length in the retention state, a material of the protruding housing element retains the seal in the retention state.

18. The connector of claim 17, wherein the protruding housing element is heat swaged to transfer the retainer from the installation state to the retention state, the protruding housing element has a flange formed by the heat swaging that retains the seal in the retention state.

19. The connector of claim 16, wherein the retainer is a hinge retainer that has an arm connected to the housing by a living hinge, the hinge retainer is rotatable about the living hinge from the installation state to the retention state.

20. The connector of claim 19, wherein the hinge retainer has a latch post with a latch protrusion, the arm of the hinge retainer has a hinge protrusion that engages with the latch protrusion in the retention state.
